(19) United States
(12) Patent Application Publication
(10) Pub. No.: US 2023/0072343 A1
(43) Pub. Date: Mar. 9, 2023

(54) VEHICLE OCCUPANT MONITORING DEVICE AND METHOD

(71) Applicant: HL KLEMOVE CORP., Incheon (KR)

(72) Inventor: Soo Hyun KO, Gyeonggi-do (KR)

(21) Appl. No.: 17/882,494

(22) Filed: Aug. 5, 2022

(30) Foreign Application Priority Data
Sep. 6, 2021 (KR) 10-2021-0118491

(51) Int. Cl. G07C 5/08; G06N 20/00

(52) U.S. Cl. CPC G07C 5/0808; G07C 5/085; G06N 20/00

(57) ABSTRACT

The present disclosure relates to a vehicle occupant monitoring device and method capable of accurately predicting the number of passengers in a vehicle without help of expensive equipment. A vehicle occupant monitoring device includes a vehicle data provider 100 configured to provide vehicle data collected from a vehicle, and an occupant prediction service provider 200 configured to predict vehicle occupants by analyzing the vehicle data from the vehicle data provider 100 by an artificial intelligence method.

### CROSS-REFERENCE TO RELATED APPLICATION

This application claims priority under 35 U.S.C. § 119 to Korean Patent Application No. 10-2021-0118491, filed on Sep. 6, 2021, in the Korean Intellectual Property Office (KIPO), the disclosure of which is incorporated by reference herein in its entirety.

### TECHNICAL FIELD

One or more example embodiments relate to a vehicle occupant monitoring device, and more particularly, to a vehicle occupant monitoring device and method capable of accurately predicting the number of passengers in a vehicle without help of expensive equipment.

### BACKGROUND

For vehicle management of fleet vehicle companies such as rental cars, taxis and shared vehicles, it is required to accurately count the number of occupants in a vehicle.

An expensive ultrasonic sensor or pressure sensor is required to detect the number of occupants or overload in the vehicle.

### SUMMARY

Example embodiments provide a vehicle occupant monitoring device and method capable of accurately predicting the number of passengers in a vehicle without the help of expensive equipment.

According to an aspect, there is provided a vehicle occupant monitoring device including a vehicle data provider 100 configured to provide vehicle data collected from a vehicle, and an occupant prediction service provider 200 configured to predict vehicle occupants by analyzing the vehicle data from the vehicle data provider 100 by an artificial intelligence method.

The vehicle data may include an inertia signal of the vehicle and a diagnostic signal of the vehicle.

The vehicle data provider 100 may include an inertia signal collector 110 configured to collect the inertia signal from an inertia measuring device 810 of the vehicle, a diagnostic signal collector 120 configured to collect the diagnostic signal from on-board diagnostic of the vehicle, and a data gatherer 130 configured to gather the inertia signal from the inertia signal collector 110 and the diagnostic signal from the diagnostic signal collector 120.

The inertia signal may include a lateral direction acceleration of the vehicle, a longitudinal direction acceleration of the vehicle, a vertical direction acceleration of the vehicle, a yaw of the vehicle, a roll of the vehicle, and a pitch of the vehicle, and the diagnostic signal may include a vehicle speed of the vehicle, an opening degree of a throttle valve of the vehicle, an engine speed of the vehicle, an engine torque of the vehicle, a slope of the vehicle, a wheel speed of the vehicle, and a steering signal of the vehicle.

The occupant prediction service provider 200 may include a feature extractor 300 configured to extract feature data based on the vehicle data from the vehicle data provider 100, an occupant predictor 400 configured to predict the vehicle occupants by analyzing the feature data from the feature extractor 300 by an artificial intelligence method, a setting value storage 600 in which model setting values calculated by machine learning of the artificial intelligence method are stored in advance to infer the vehicle occupants corresponding to the vehicle data, and configured to provide the occupant predictor 400 with a statistic of the vehicle data among the model setting values, and a setting value loader 500 configured to load a weight and a bias value of vehicle data among the model setting values from the setting value storage 600 into the occupant predictor 400.

The feature extractor 300 may include an original storage 310 configured to store vehicle data input from an outside, and a data extractor 320 configured to extract feature data from the vehicle data of the original storage 310.

The occupant prediction service provider 200 may further include a predicted value storage 700 configured to store a value of the vehicle occupants predicted by the occupant predictor 400.

The data extractor 320 may include a data corrector 321 configured to generate a corrected inertia signal based on the vehicle data of the original storage 310 and the center of gravity of the vehicle, a vehicle speed calculator 322 configured to calculate a vehicle speed of the vehicle based on the vehicle data of the original storage 310, a slope calculator 323 configured to calculate a slope of the vehicle based on the vehicle data of the original storage 310 and the corrected inertia signal, a lateral direction speed calculator 324 configured to calculate a lateral direction speed of the vehicle based on the vehicle data of the original storage 310 and the corrected inertia signal, a rainfall determinator 325 configured to calculate water quantity applied to the vehicle based on the vehicle data of the original storage 310, a fuel weight calculator 326 configured to calculate a fuel weight of the vehicle based on the vehicle data of the original storage 310, and a data gatherer 130 configured to generate the feature data by gathering the corrected inertia signal from the data corrector 321, the vehicle speed from the vehicle speed calculator 322, the slope from the slope calculator 323, the lateral direction speed from the lateral direction speed calculator 324, the water quantity from the rainfall determinator 325, and the fuel weight from the fuel weight calculator 326, and output the generated feature data as one data set.

The occupant predictor 400 may include a normalizer 410 configured to normalize the feature data from the feature extractor 300 based on an average and standard deviation of the vehicle data provided from the setting value storage 600, a model generator 420 configured to generate an occupant prediction model based on the weight and the bias value of the vehicle data loaded from the setting value storage 600, and a predicted value outputter 430 configured to input the normalized feature data from the normalizer 410 to the occupant prediction model from the model generator 420 and output a value of the vehicle occupant.

The vehicle occupant monitoring device may further include an instructor 820 configured to instruct the vehicle data provider 100 to collect and gather the vehicle data from the vehicle by detecting movement of the vehicle.

According to another aspect, there is provided a vehicle occupant monitoring method including providing vehicle data collected from a vehicle, and predicting vehicle occupants by analyzing the provided vehicle data by an artificial intelligence method.

The providing of the vehicle data may include collecting an inertia signal from the vehicle, collecting a diagnostic signal from the vehicle, and gathering the inertia signal and the diagnostic signal.

The vehicle occupant monitoring method may further include storing a model setting value calculated by machine learning of the artificial intelligence method in advance to infer the vehicle occupants corresponding to the vehicle data, wherein the predicting of the occupants may include extracting feature data based on the provided vehicle data, and predicting the vehicle occupants by analyzing the extracted feature data by the artificial intelligence method through an occupant prediction model set based on the model setting value.

The extracting of the feature data may include storing vehicle data input from an outside, and extracting the feature data from the stored vehicle data.

The vehicle occupant monitoring method may further include storing a value of the predicted vehicle occupants.

The extracting of the feature data may include generating a corrected inertia signal of the vehicle by correcting an inertia signal based on the stored vehicle data and the center of gravity of the vehicle, calculating a vehicle speed of the vehicle based on the stored vehicle data, calculating a slope of the vehicle based on the stored vehicle data and the corrected inertia signal, calculating a lateral direction speed of the vehicle based on the stored vehicle data and the corrected inertia signal, calculating water quantity applied to the vehicle based on the stored vehicle data, calculating a fuel weight of the vehicle based on the stored vehicle data, and generating the feature data by gathering the calculated corrected inertia signal, the vehicle speed, the slope, the lateral direction speed, the water quantity, and the fuel weight to output the generated feature data as one data set.

The predicting of the vehicle occupants by analyzing the extracted feature data by the artificial intelligence method may include normalizing the feature data from a feature extractor 300 based on an average and standard deviation of the vehicle data included in the model setting value, generating an occupant prediction model based on a weight and a bias value of the vehicle data included in the model setting value, and inputting the normalized feature data to the occupant prediction model and outputting a value of the vehicle occupants.

The vehicle occupant monitoring method may further include instructing to collect and gather the vehicle data from the vehicle by detecting movement of the vehicle.

According to a vehicle occupant monitoring device and method of example embodiments, it is possible to analyze vehicle data (e.g., CAN data of a vehicle) by the artificial intelligence method, and accurately predict vehicle occupants (e.g., the number of passengers in the vehicle) through a model by machine learning.

Therefore, according to the vehicle occupant monitoring device and method of example embodiments, it is possible to determine the vehicle occupants accurately and quickly.

In addition, according to the vehicle occupant monitoring device and method of example embodiments, expensive equipment is not required, thereby reducing the cost of checking the vehicle occupant.

The vehicle occupant monitoring device and method of example embodiments may be utilized in fleet vehicle companies such as rental cars, taxis, and shared vehicles.

### BRIEF DESCRIPTION OF THE DRAWINGS

FIG. 1 is a block diagram illustrating a vehicle occupant monitoring device according to an example embodiment;

FIG. 2 is a block diagram illustrating a vehicle terminal;

FIG. 3 is a detailed block diagram illustrating an occupant prediction service provider of FIG. 1;

FIG. 4 is a detailed block diagram illustrating a data extractor of FIG. 3;

FIG. 5 is a detailed block diagram illustrating an occupant predictor of FIG. 3;

FIG. 6 is a flowchart illustrating a vehicle occupant monitoring method according to an example embodiment;

FIG. 7 is a flowchart illustrating an operation of providing vehicle data of FIG. 6;

FIG. 8 is a flowchart illustrating an operation of predicting occupants in FIG. 6;

FIG. 9 is a flowchart illustrating an operation of extracting feature data of FIG. 8;

FIG. 10 is a flowchart illustrating an operation of extracting the feature data of FIG. 9;

FIG. 11 is a flowchart illustrating an operation of predicting vehicle occupants by an artificial intelligence method of FIG. 8;

FIG. 12 is a diagram illustrating a loss function having a weight and a bias value applied to a vehicle occupant prediction model as parameters according to an example embodiment; and

FIG. 13 is a histogram graph illustrating error frequency between a predicted value and an actual value of a vehicle occupant prediction model according to an example embodiment.

### DETAILED DESCRIPTION

Aspects, features, and advantages of the invention will become apparent and more readily appreciated from the following detailed description of example embodiments, taken in conjunction with the accompanying drawings. The present disclosure is not limited by example embodiments disclosed below, but example embodiments may be implemented in various different forms. The example embodiments are provided to complete the disclosure of the present invention, and to fully inform those of ordinary skill in the art of the scope of the present invention. The scope of the disclosure should be defined by the appended claims. Accordingly, in some example embodiments, well-known process steps, well-known device structures, and well-known techniques have not been specifically described in order to avoid obscuring the present disclosure. Throughout the specification, the same reference numeral refers to the same components.

In the drawings, the thickness of layers and regions may be exaggerated for clarity. Like reference numerals refer to like components throughout the specification.

Although terms of “first,” “second,” and the like are used to explain various components, the components are not limited to such terms. These terms are used only to distinguish one component from another component. For example, a first component may be referred to as a second component or a third component, or similarly, the second component or the third component may be referred to as the first component within the scope of the present disclosure.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

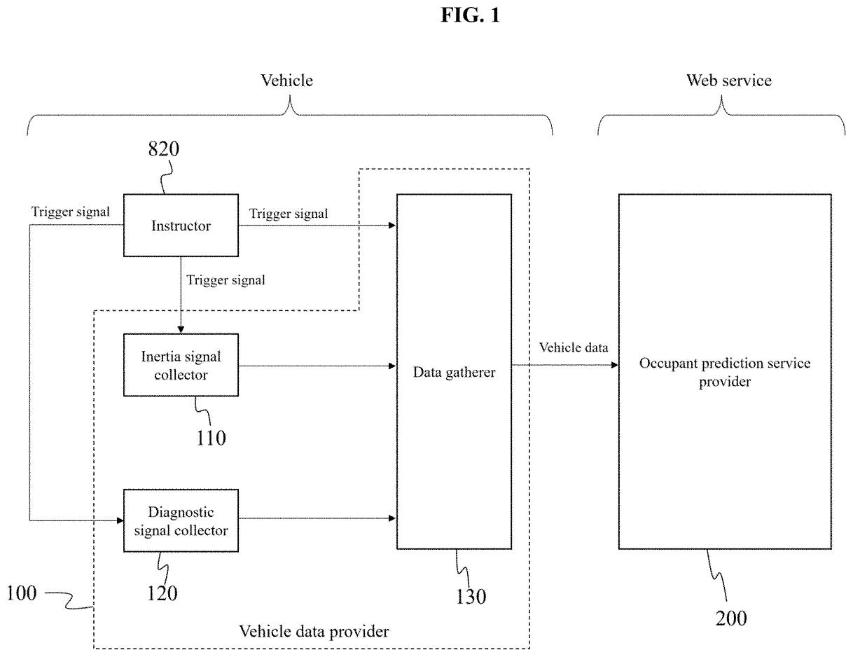

Hereinafter, a vehicle occupant monitoring device and method according to example embodiments will be described in detail with reference to FIG. 1 to FIG. 13.

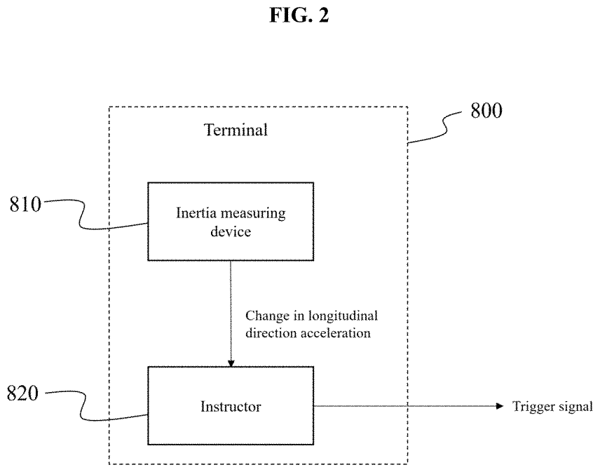

FIG. 1 is a block diagram illustrating a vehicle occupant monitoring device according to an example embodiment, and FIG. 2 is a block diagram illustrating a vehicle terminal 800.

As shown in FIG. 1, a vehicle occupant monitoring device according to an example embodiment may include an instructor 820, a vehicle data provider 100, and an occupant prediction service provider 200. Here, the instructor 820 and the vehicle data provider 100 may be disposed in a vehicle, and the occupant prediction service provider 200 may be provided, for example, based on a web service.

The instructor 820 may detect movement of the vehicle and determine whether to output a trigger signal based on the detection result. As illustrated in FIG. 2, the instructor 820 may be built in a terminal 800 of the vehicle. The terminal 800 includes an inertia measuring device 810 therein. When the vehicle moves as the accelerator pedal of the vehicle is pressed, the inertia measuring device 810 detects the motion of the vehicle and outputs detected signal (e.g., an amount of changes in a longitudinal direction acceleration). At this time, the detected signal from the inertia measuring device 810 is transmitted to the instructor 820 inside the terminal 800, and the instructor 820 may recognize the movement of the vehicle based on the transmitted detected signal. The instructor 820 outputs the trigger signal as an input result of such a detected signal. In other words, this trigger signal may be a signal indicating that the vehicle is moving. The trigger signal from the instructor 820 may be transmitted to the vehicle data provider 100.

The vehicle data provider 100 may collect and gather vehicle data from the vehicle in response to the trigger signal from the instructor 820, and transmit the gathered vehicle data to the occupant prediction service provider 200.

The above-described vehicle data is control area network (CAN) data for communication between various electronic components (and/or electronic control units) of the vehicle, and such vehicle data may include, for example, longitudinal direction feature data, lateral direction feature data, vertical direction feature data, and environmental variable feature data that may affect weight of the vehicle.

The above-described longitudinal direction feature data may include, for example, an opening degree of a throttle valve (e.g., a position of the throttle valve) of the vehicle, an engine speed of the vehicle, an engine torque of the vehicle, a vehicle speed (e.g., an engine RPM (Revolution Per Minute)) of the vehicle, a longitudinal direction acceleration of the vehicle, a slope of the vehicle, a pitch of the vehicle, and a wheel slip of the vehicle. Here, the longitudinal direction means a direction parallel to a traveling direction of the vehicle. For example, assuming that an axis connecting the front of the vehicle and the rear of the vehicle is an x-axis, the above-described longitudinal direction means a direction along the x-axis. The slope of the vehicle means an angle in which the vehicle is inclined with respect to the ground. For example, the slope of the vehicle means an angle between the ground on which the vehicle is located and the longitudinal axis (i.e., the x-axis) of the vehicle. Physical quantity of the longitudinal direction feature data listed above may mean, for example, an average value. As a specific example, the vehicle speed may be an average vehicle speed within a predetermined period.

The above-described lateral direction feature data may include, for example, a steering angle of a steering device of the vehicle, a yaw (or yaw rate) of the vehicle, a roll of the vehicle, a lateral direction speed of the vehicle, and a lateral direction acceleration of the vehicle. Here, the lateral direction means a direction connecting side surfaces of the vehicle. For example, assuming that an axis connecting the left side of the vehicle and the right side of the vehicle facing the left side is a y-axis, the above-described longitudinal direction means a direction along this y-axis. The y-axis intersects the x-axis perpendicularly. Further, the physical quantity of the lateral direction feature data listed above may mean, for example, an average value. As a specific example, the lateral direction acceleration of the vehicle may be an average lateral direction acceleration within a predetermined period. Further, the steering angle of the steering device may be detected by, for example, a steering angle sensor of the vehicle.

The above-described vertical direction feature data may include, for example, a vertical direction acceleration of the vehicle. Here, the vertical direction means a direction connecting the lower surface and the upper surface of the vehicle. For example, assuming that an axis connecting the lower surface of the vehicle and the upper surface of the vehicle facing the lower surface is a z-axis, the above-described vertical direction means a direction along the z-axis. The z-axis is perpendicular to the xy plane (i.e., the plane formed by the x-axis and the y-axis described above). Physical quantity of the vertical direction feature data may mean, for example, an average value. As a specific example, the vertical direction acceleration of the vehicle may be an average vertical direction acceleration within a predetermined period. Further, this vertical direction acceleration may be affected by the suspension and tires of the vehicle.

The above-described environmental variable feature data may include, for example, the weight of the vehicle (e.g., an empty weight of the vehicle), drivetrain information of the vehicle (e.g., engine displacement of the vehicle and transmission type of the vehicle), fuel weight of the vehicle (or an amount of fuel), vehicle identification number, total distance (or mileage) of the vehicle, outdoor air temperature of the vehicle, weather (e.g., rain or snow), and time stamp. Here, the time stamp may include time at which the vehicle data provider 100 collects the vehicle data from the vehicle. In addition, weather information may include water quantity information such as rain. In this case, the water quantity information may be obtained from, for example, a rain sensor of the vehicle.

The vehicle data provider 100 collecting such vehicle data may include, for example, an inertia signal collector 110 and a diagnostic signal collector 120.

The inertia signal collector 110 may collect an inertia signal from the inertia measuring device 810. For example, the inertia signal collector 110 may collect the inertia signal from the inertia measuring device 810 in response to the trigger signal from the instructor 820. The inertia signal may include, for example, the longitudinal direction acceleration (e.g., Ax), the lateral direction acceleration (e.g., Ay), the vertical direction acceleration (e.g., Az), the yaw, the roll, and the pitch as described above.

The diagnostic signal collector 120 may collect a diagnostic signal from on-board diagnostic (OBD) of the vehicle. For example, the diagnostic signal collector 120 may collect the diagnostic signal through the OBD in response to the trigger signal from the instructor 820. The diagnostic signal may include, for example, the above-described vehicle speed, the opening degree of the throttle valve, the engine speed, the engine torque, the slope, a wheel speed of the vehicle and the steering angle. Here, the wheel speed may include the speed of the front left wheel, the speed of the front right wheel, the speed of the rear left wheel, and the speed of the rear right wheel of the vehicle. In addition to this, the diagnostic signal may further include at least one of, for example, the wheel slip, the lateral direction speed, the vertical direction acceleration, the weight of the vehicle, the drivetrain information of the vehicle, the fuel weight of the vehicle, the vehicle identification number, the total distance of the vehicle, the outdoor air temperature of the vehicle, the weather information, and the time stamp.

A data gatherer 130 may gather the inertia signal from the inertia signal collector 110 and the diagnostic signal from the diagnostic signal collector 120. For example, the data gatherer 130 may gather the inertia signal from the Inertia signal collector 110 and the diagnostic signal from the diagnostic signal collector 120 in response to the trigger signal from the instructor 820, and may provide the occupant prediction service provider 200 with the gathered vehicle data (i.e., the vehicle data including the inertia signal and the diagnostic signal). For example, the data gatherer 130 may gather the longitudinal direction acceleration, the lateral direction acceleration, the vertical direction acceleration, the yaw, the roll, the pitch, the vehicle speed, the opening degree of the throttle valve, the engine speed, the engine torque, the slope, the wheel speed, and the steering angle as one data set, and may provide the occupant prediction service provider 200 with the gathered vehicle data.

The occupant prediction service provider 200 may predict vehicle occupants by analyzing the vehicle data from the vehicle data provider 100 by an artificial intelligence method. For example, the occupant prediction service provider 200 may predict the number of occupants in the vehicle, by receiving the vehicle data from the data gatherer 130 of the vehicle data provider 100, and analyzing the received vehicle data by the artificial intelligence method. Here, the number of passengers may mean the number excluding a driver. In this case, the above-described empty vehicle weight may mean the weight of the vehicle including the driver of the vehicle.

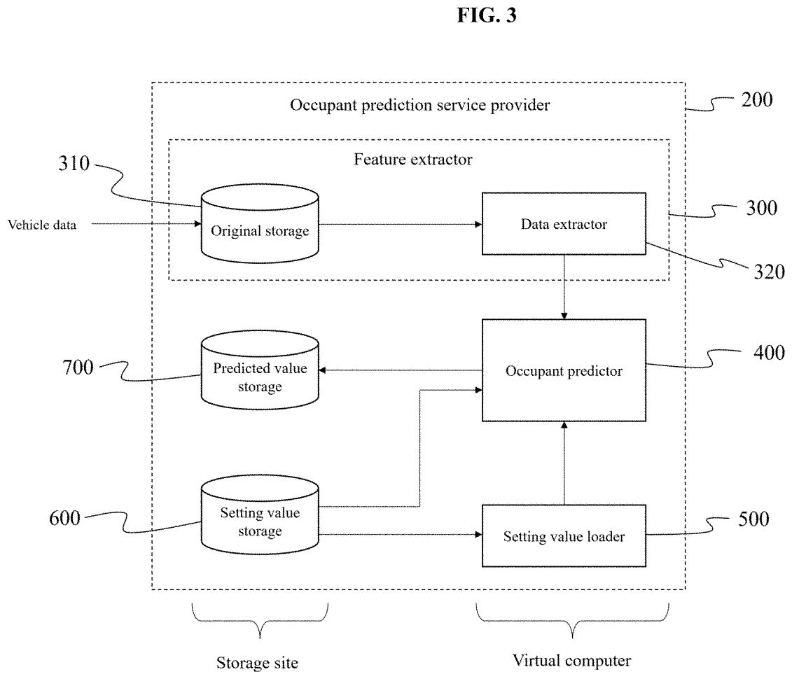

FIG. 3 is a detailed block diagram illustrating the occupant prediction service provider 200 of FIG. 1.

As shown in FIG. 3, the occupant prediction service provider 200 may include a feature extractor 300, an occupant predictor 400, a setting value storage 600, and a setting value loader 500. For this, the feature extractor 300 may include, for example, an original storage 310 and a data extractor 320.

The original storage 310 may store vehicle data input from the outside. For example, in this original storage 310, the longitudinal direction acceleration, the lateral direction acceleration, the vertical direction acceleration, the yaw, the roll, the pitch, the vehicle speed, the opening degree of the throttle valve, the engine speed, the engine torque, the slope, the wheel speed and the steering angle gathered as one data set may be stored. In addition to this, at least one of wheel slip, lateral direction speed, vertical direction acceleration, weight of the vehicle, drivetrain information of the vehicle, fuel weight of the vehicle, vehicle identification number, total distance of the vehicle, outdoor air temperature of the vehicle, weather information and time stamp may be stored in this original storage 310.

The data extractor 320 may extract the feature data from the vehicle data stored in the original storage 310. This feature data may include, for example, a corrected inertia signal, a corrected vehicle speed, a corrected slope, a corrected lateral direction speed, water quantity, and fuel quantity. Here, the corrected inertia signal means an inertia signal corrected based on the center of gravity of the vehicle. The corrected vehicle speed means a vehicle speed corrected based on the corrected inertia signal (especially, longitudinal direction acceleration and lateral direction acceleration). The corrected slope means a slope corrected based on the corrected inertia signal. The corrected lateral direction speed means a lateral direction speed corrected based on the corrected inertia signal.

The occupant predictor 400 may predict the vehicle occupants by analyzing the feature data from the feature extractor 300 by the artificial intelligence method.

The setting value storage 600 may store in advance model setting values calculated by machine learning of the artificial intelligence method to infer vehicle occupants corresponding to the vehicle data. The model setting values may include, for example, a statistic of the vehicle data, a weight of the vehicle data, and a bias value of the vehicle data. In this case, the setting value storage 600 may provide the occupant predictor 400 with the statistic of the vehicle data among the model setting values. Further, the statistic of the model setting value may include, for example, an average of the vehicle data and standard deviation of the vehicle data.

The setting value storage 600 may store a predetermined model setting value. This model setting value is data stored in advance in the setting value storage 600.

The above-described model setting values may be calculated through, for example, machine learning of the artificial intelligence method so as to infer the number of occupants of the vehicle corresponding to the vehicle data. As a specific example, the above-described model setting values may be calculated through machine learning on predetermined data for learning. Here, the data for learning may be data (or a data set) corresponding to the above-described vehicle data. Through machine learning by this data for learning, the model learner may generate model setting values that enable inference of the number of vehicle occupants corresponding to the above-described vehicle data. For example, the model setting values may include the weight and bias value minimizing the value of a loss function (or a cost function).

For this, the model learner may include, for example, a feature extractor for learning and a setting value generator.

The feature extractor for learning may extract feature data for learning from the data for learning.

The setting value generator may generate a learning model based on the feature data for learning from the feature extractor for learning, and train the generated learning model to generate the model setting value. Contrary to the vehicle data, the data for learning may further include information on the number of vehicle occupant, and the number of vehicle occupants includes a label. In other words, the data for learning may include the label corresponding to a class of input data (e.g., the number of vehicle occupant).

A machine learning model is a file trained to recognize certain types of patterns, and trains the model on data set (e.g., the input data described above) to provide algorithms that may be used to infer and learn from that data. After training the model, it is possible to infer previously unmarked (i.e., unlabeled) input data and make predictions on that input data (e.g., predictions on class).

Further, the machine learning model may include, for example, an artificial neural network such as a deep learning, neural network, a convolutional neural network, and a recurrent neural network.

Assuming that the input data given based on pre-known feature data (e.g., vehicle data including no labels) belong to any one of a plurality of a predetermined classes (e.g., the predictable number of vehicle occupants), such machine learning is it may be aimed at determining which class of the plurality of classes new input data belongs to.

The setting value loader 500 may load weight and bias value of the vehicle data among the model setting value from the setting value storage 600 into the occupant predictor 400.

The predicted value storage 700 stores the number of vehicle occupants predicted by the occupant predictor 400.

Further, the above-described original storage 310, the predicted value storage 700, and the setting value storage 600 may be disposed in, for example, a storage site of the web service. In addition, the above-described data extractor 320, the occupant predictor 400, and the setting value loader 500 may be disposed in, for example, a virtual computer of the web service.

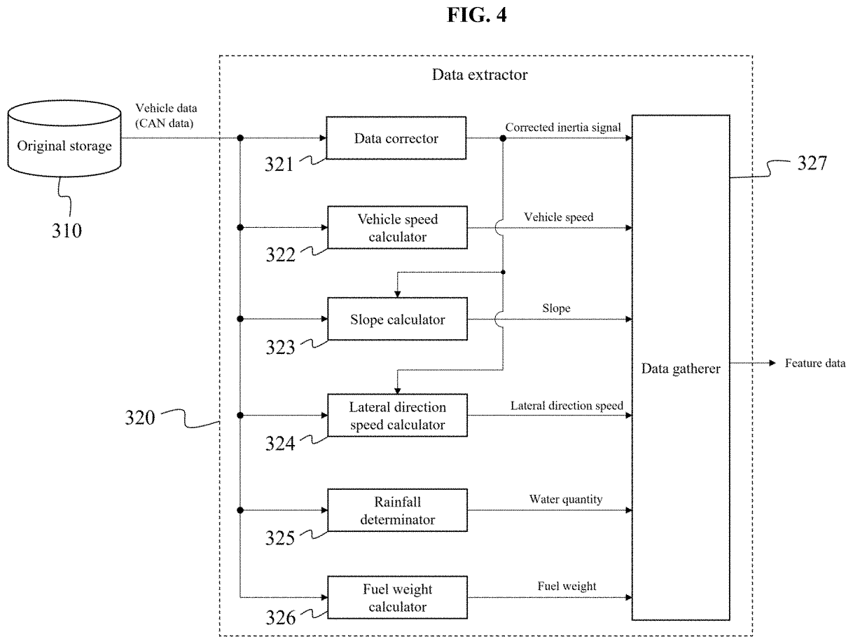

FIG. 4 is a detailed block diagram illustrating a data extractor of FIG. 3.

As shown in FIG. 4, the data extractor 320 may include a data corrector 321, a vehicle speed calculator 322, a slope calculator 323, a lateral direction speed calculator 324, a rainfall determinator 325, and a fuel weight calculator 326.

The data corrector 321 may generate a corrected inertia signal based on the vehicle data of the original storage 310 and the center of gravity of the vehicle. In other words, since a terminal 800 in which an inertia measuring device 810 is built is generally located in the front inside the vehicle (e.g., dashboard), the inertia signal from the inertia measuring device 810 may not reflect movement information of the vehicle. In other words, the inertia measuring device 810 built in the terminal 800 cannot be located at the center of gravity of the vehicle due to the disposition of the terminal 800, so that the inertia signal from the inertia measuring device 810 may not be accurate. Accordingly, the above-described data corrector 321 may correct the inertia signal among the vehicle data, for example, the longitudinal direction acceleration, the lateral direction acceleration, the vertical direction acceleration, the yaw, the roll, and the pitch based on the center of gravity of the vehicle.

The vehicle speed calculator 322 calculates vehicle speed of the vehicle based on the vehicle data of the original storage 310 and the corrected inertia signal. For example, the vehicle speed calculator 322 may calculate the vehicle speed based on a wheel speed of a wheel rotating the fastest among the plurality of wheels. Then, the vehicle speed calculator 322 corrects and outputs the calculated vehicle speed based on the longitudinal direction acceleration and the lateral direction acceleration.

The slope calculator 323 may calculate slope based on the vehicle data of the original storage 310 and the corrected inertia signal.

The lateral direction speed calculator 324 may calculate lateral direction speed of the vehicle based on the vehicle data of the original storage 310 and the corrected inertia signal.

The rainfall determinator 325 may calculate the water quantity applied to the vehicle based on the vehicle data of the original storage 310. For example, this water quantity may be measured by a rain sensor.

The fuel weight calculator 326 may calculate the fuel weight of the vehicle based on the vehicle data of the original storage 310.

A data gatherer 327 may generate feature data by gathering the corrected inertia signal from the data corrector 321, the vehicle speed from the vehicle speed calculator 322, the slope from the slope calculator 323, the lateral direction speed from the lateral direction speed calculator 324, the water quantity from the rainfall determinator 325, and the fuel weight from the fuel weight calculator 326, and output the generated feature data as one data set.

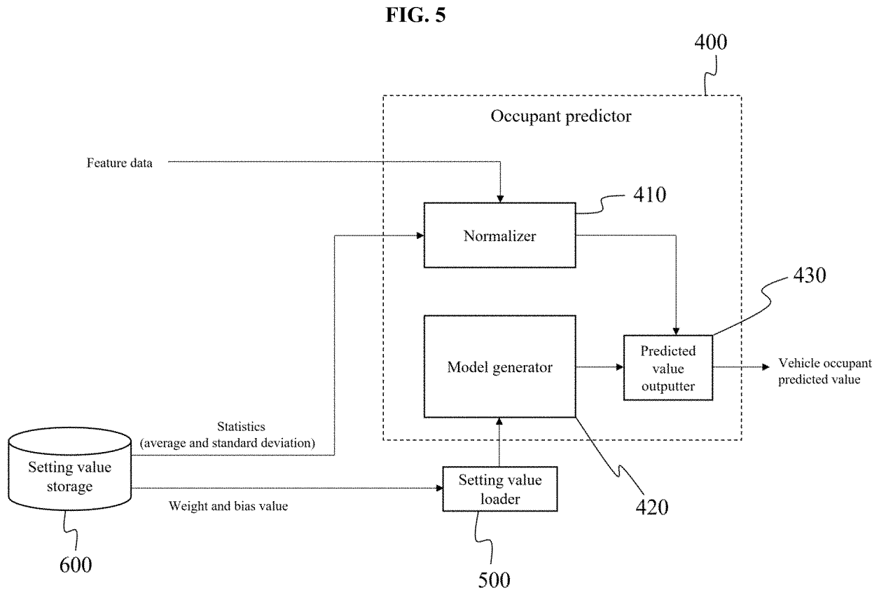

FIG. 5 is a detailed block diagram illustrating an occupant predictor of FIG. 3.

As shown in FIG. 5, the occupant predictor 400 may include a normalizer 410, a model generator 420, and a predicted value outputter 430.

The normalizer 410 may normalize the feature data from the feature extractor 300 based on the average and standard deviation of the vehicle data provided from the setting value storage 600.

The model generator 420 may generate an occupant prediction model based on weight and bias value of the vehicle data loaded from the setting value storage 600.

The predicted value outputter 430 may input the normalized feature data from the normalizer 410 into the occupant prediction model from the model generator 420 and output a value of the vehicle occupant. Further, the value of the vehicle occupants from the predicted value outputter 430 may be transmitted to the customer through cloud system. The customer may be fleet vehicle companies such as rental cars, taxis and shared vehicles. In addition, the value of the vehicle occupants from the predicted value outputter 430 may be stored in a storage site of the web service, for example, the predicted value storage 700.

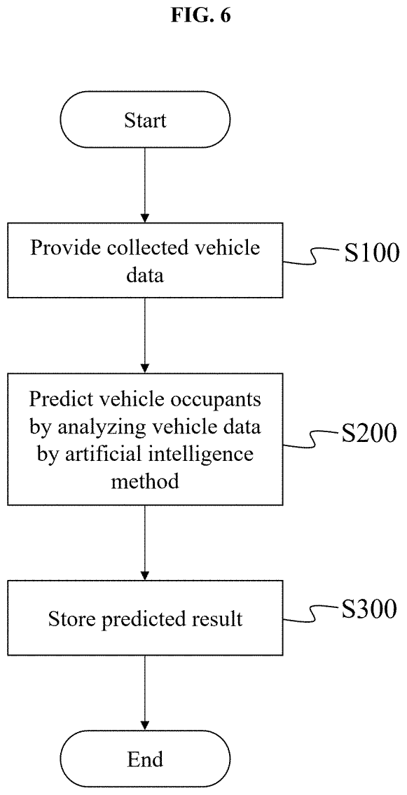

FIG. 6 is a flowchart illustrating a vehicle occupant monitoring method according to an example embodiment.

The vehicle occupant monitoring method according to an example embodiment may include the following operations.

For example, as shown in FIG. 6, according to the vehicle occupant monitoring method according to an example embodiment, an operation of providing the vehicle data collected from the vehicle is first performed (S100).

Thereafter, an operation of predicting the vehicle occupants by analyzing the provided vehicle data by the artificial intelligence method is performed (S200).

An operation of storing the predicted result (i.e., the predicted vehicle occupants) may be further performed (S300).

Further, prior to the operation of providing the vehicle data, an operation of instructing to collect and gather the vehicle data from the vehicle by detecting the movement of the vehicle may be performed.

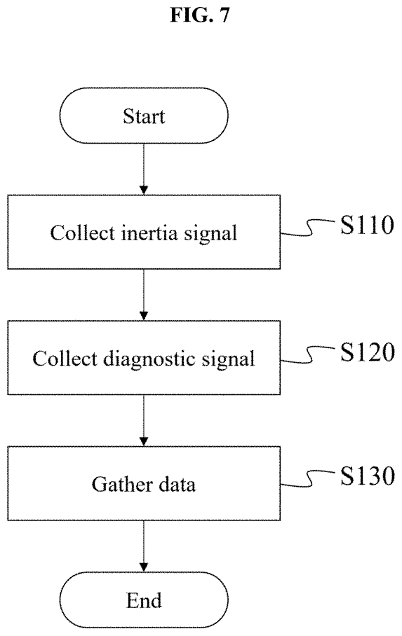

FIG. 7 is a flowchart illustrating the operation of providing the vehicle data of FIG. 6.

The operation of providing the vehicle data may include operations as shown in FIG. 7.

In other words, first, an operation of collecting an inertia signal from the inertia measuring device 810 of the vehicle is performed (S110).

Next, an operation of collecting the diagnostic signal from the OBD of the vehicle is performed (S120).

Thereafter, an operation of gathering the inertia signal from the inertia signal collector 110 and the diagnostic signal from the diagnostic signal collector 120 is performed (S130).

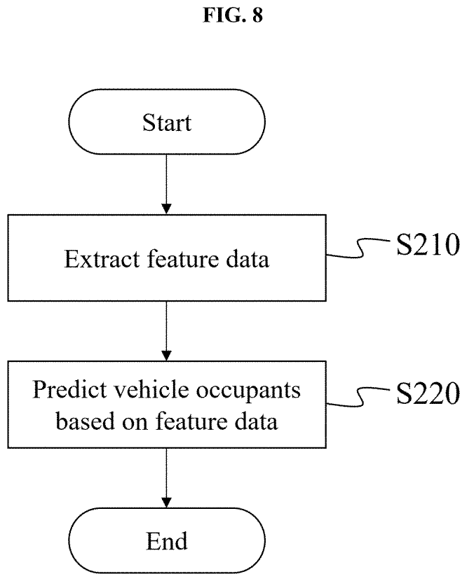

FIG. 8 is a flowchart illustrating the operation of predicting the occupants in FIG. 6.

The operation of predicting of the occupants may include operations as shown in FIG. 8.

First, an operation of extracting the feature data based on the provided vehicle data is performed (S210).

Thereafter, an operation of predicting the vehicle occupants by analyzing the extracted feature data by the artificial intelligence method through the occupant prediction model set based on the model setting value is performed (S220).

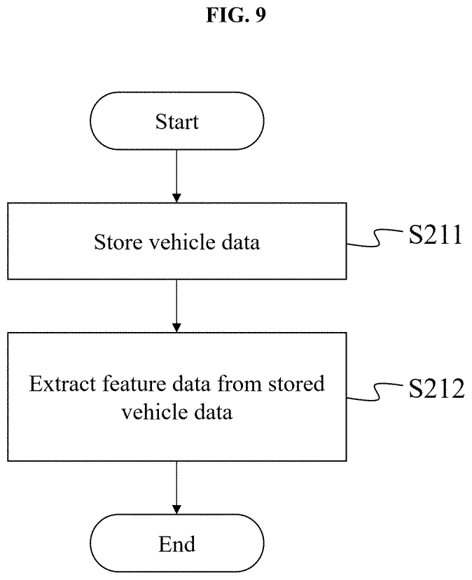

FIG. 9 is a flowchart illustrating the operation of extracting the feature data of FIG. 8.

The operation of extracting of the feature data may include operations as shown in FIG. 9.

First, an operation of storing the vehicle data inputted from the outside is performed (S211).

Thereafter, an operation of extracting the feature data from the stored vehicle data is performed (S212).

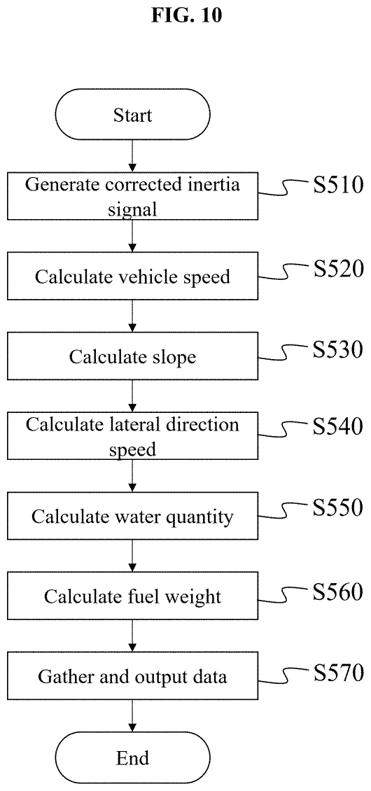

FIG. 10 is a flowchart illustrating the operation of extracting the feature data of FIG. 9.

The operation of extracting of the feature data may include operations as shown in FIG. 10.

First, an operation of generating the corrected inertia signal by correcting the inertia signal based on the stored vehicle data and the center of gravity of the vehicle is performed (S510).

Then, an operation of calculating the vehicle speed of the vehicle based on the stored vehicle data is performed (S520).

Thereafter, an operation of calculating the slope of the vehicle based on the stored vehicle data and the corrected inertia signal is performed (S530).

Then, an operation of calculating the lateral direction speed of the vehicle based on the stored vehicle data and the corrected inertia signal is performed (S540).

Then, an operation of calculating the water quantity applied to the vehicle based on the stored vehicle data is performed (S550).

Thereafter, an operation of calculating the fuel weight of the vehicle based on the stored vehicle data is performed (S560).

Then, an operation of generating the feature data by gathering the calculated corrected inertia signal, vehicle speed, slope, lateral direction speed, water quantity, and fuel weight, and outputting the generated feature data as one data set is performed (S570).

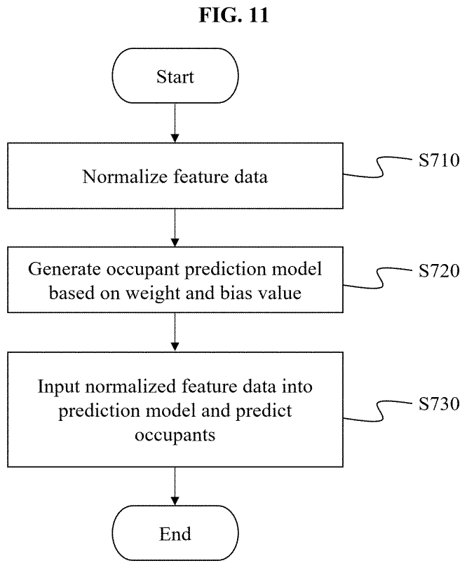

FIG. 11 is a flowchart illustrating the operation of predicting the vehicle occupants by the artificial intelligence method of FIG. 8.

The operation of predicting of the vehicle occupants by analyzing the extracted feature data by the artificial intelligence method may include operations as shown in FIG. 11.

First, an operation of normalizing the feature data from the feature extractor 300 based on the average and standard deviation of the vehicle data included in the model setting value is performed (S710).

Thereafter, an operation of generating the occupant prediction model based on the weight and bias value of the vehicle data included in the model setting values is performed (S720).

Then, an operation of inputting the normalized feature data into the occupant prediction model and outputting a value of the vehicle occupants is performed (S730).

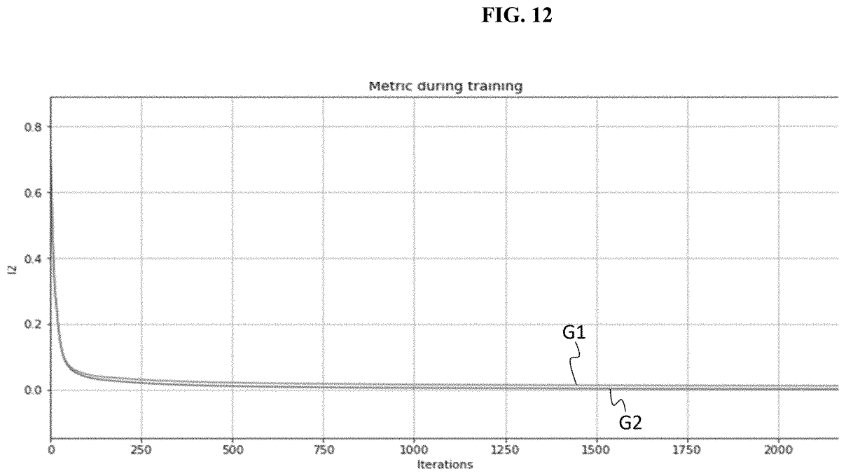

FIG. 12 is a diagram illustrating a loss function having a weight and bias value applied to a vehicle occupant prediction model as parameters according to an example embodiment.

As shown in FIG. 12, the weight and the bias value stored in the setting value storage 600 of the present disclosure are optimized values to minimize the value of the loss function.

As shown in FIG. 12, a loss function G1 of the vehicle occupant prediction model of the present disclosure and a loss function G2 by learning data including the label are similar, and also converged to zero (0). It can be seen that the predicted value of the vehicle occupant prediction model of the present disclosure is quite accurate.

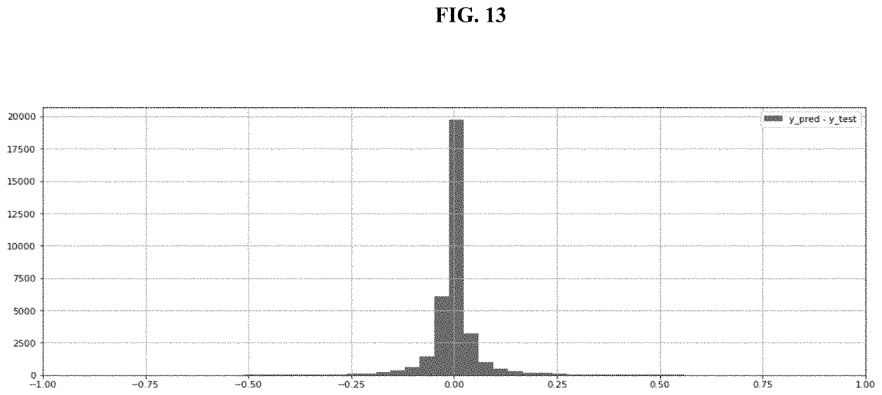

FIG. 13 is a histogram graph illustrating error frequency between a predicted value and an actual value of the vehicle occupant prediction model according to an example embodiment.

As shown in FIG. 13, it can be seen that a value having a difference of zero (0) between a predicted value y_pred and an actual value y_test has the highest frequency. In other words, it can be seen that the difference between the predicted value y_pred and the actual value y_test (i.e., an error) converges to almost zero (0). Therefore, it can be seen that the predicted value (y_pred) of the vehicle occupant prediction model according to an example embodiment is quite accurate.

It may be appreciated that each block of flowcharts and combinations of the flowcharts may be executed by computer program instructions. These computer program instructions may be loaded on a processor of a general purpose computer, special purpose computer, or programmable data processing equipment. When the loaded program instructions are executed by the processor, they create means for carrying out functions described in the blocks of the flowcharts. The computer program instructions may also be stored in a non-transitory computer-usable or computer-readable memory that may direct a computer or other programmable data processing equipment to implement a function in a particular manner. Accordingly, it is also possible to produce an article of manufacture containing instruction means for performing the functions described in the flowchart block(s) with the instructions stored in the non-transitory computer usable or computer readable memory. The computer program instructions may be embodied on a computer or other programmable data processing equipment. Accordingly, a series of operational steps may be performed on a computer or other programmable data processing equipment to create a process executed by the computer, and the instructions for controlling the computer or other programmable data processing equipment may provide steps for executing functions described in the flowchart block(s).

Each block of the flowcharts may represent a module, a segment, or a code containing one or more executable instructions executing one or more logical functions, or a part thereof. In some alternative embodiments, functions described by the blocks may be executed in an order different from the described order. For example, two blocks shown in succession may be performed substantially simultaneously, or the blocks may sometimes be performed in the reverse order according to the corresponding functions.

In the description, the word “unit” may refer to a software or hardware component such as an FPGA or ASIC capable of carrying out a function or an operation. However, the “unit” is not limited to hardware or software. The unit may be configured so as to reside in an addressable non-transitory storage medium or to drive one or more processors. As an example, the unit includes a set of components, such as software components, object-oriented software components, class components, and task components, processes, functions, properties, procedures, subroutines, segments of program codes, drivers, firmware, microcodes, circuitry, data, databases, data structures, tables, arrays, and variables. Functions provided in components and units may be combined into a smaller number of components and units, and may be divided into units with additional components. In addition, components and units may be implemented to drive a device or one or more CPUs in a secure multimedia card.

It is apparent to those skilled in the art that the present disclosure may be embodied in other specific forms without modifying the technical idea or essential characteristics of the present disclosure. Accordingly, the above described example embodiments should not be construed as restrictive in all respects but as illustrative. The scope of the present specification is indicated by the appended claims rather than the above detailed description, and all changes or modifications derived from the meaning and scope of the claims and their equivalents should be construed as being included in the scope of the present specification.

While preferable example embodiments of the present specification have been described in the present specification and accompanying drawings and specific terms have been used, these terms are only used in a general sense to easily describe the technical content of the present specification and help the understanding of the present invention, and are not intended to limit the scope of the present specification. It is apparent to those skilled in the art to which the present specification pertains that other modifications based on the technical spirit of the present specification may be implemented in addition to the embodiments disclosed herein.

What is claimed is:

1. A vehicle occupant monitoring device, comprising:
a vehicle data provider configured to provide vehicle data collected from a vehicle; and
an occupant prediction service provider configured to predict vehicle occupants by analyzing the vehicle data from the vehicle data provider by an artificial intelligence method.

2. The vehicle occupant monitoring device of claim 1, wherein the vehicle data comprises an inertia signal of the vehicle and a diagnostic signal of the vehicle.

3. The vehicle occupant monitoring device of claim 2, wherein the vehicle data provider comprises:
an inertia signal collector configured to collect the inertia signal from an inertia measuring device of the vehicle;
a diagnostic signal collector configured to collect the diagnostic signal from on-board diagnostic of the vehicle; and
a data gatherer configured to gather the inertia signal from the inertia signal collector and the diagnostic signal from the diagnostic signal collector.

4. The vehicle occupant monitoring device of claim 2, wherein the inertia signal comprises a lateral direction acceleration of the vehicle, a longitudinal direction acceleration of the vehicle, a vertical direction acceleration of the vehicle, a yaw of the vehicle, a roll of the vehicle, and a pitch of the vehicle, and
the diagnostic signal comprises a vehicle speed of the vehicle, an opening degree of a throttle valve of the vehicle, an engine speed of the vehicle, an engine torque of the vehicle, a slope of the vehicle, a wheel speed of the vehicle, and a steering signal of the vehicle.

5. The vehicle occupant monitoring device of claim 1, wherein the occupant prediction service provider comprises:
a feature extractor configured to extract feature data based on the vehicle data from the vehicle data provider;
an occupant predictor configured to predict the vehicle occupants by analyzing the feature data from the feature extractor by an artificial intelligence method;
a setting value storage in which model setting values calculated by machine learning of the artificial intelligence method are stored in advance to infer the vehicle occupants corresponding to the vehicle data, and configured to provide the occupant predictor with a statistic of the vehicle data among the model setting values; and
a setting value loader configured to load a weight and a bias value of vehicle data among the model setting values from the setting value storage into the occupant predictor.

6. The vehicle occupant monitoring device of claim 5, wherein the feature extractor comprises:
an original storage configured to store vehicle data input from an outside; and
a data extractor configured to extract feature data from the vehicle data of the original storage.

7. The vehicle occupant monitoring device of claim 5, wherein the occupant prediction service provider further comprises a predicted value storage configured to store a value of the vehicle occupants predicted by the occupant predictor.

8. The vehicle occupant monitoring device of claim 6, wherein the data extractor comprises:
a data corrector configured to generate a corrected inertia signal based on the vehicle data of the original storage and the center of gravity of the vehicle;
a vehicle speed calculator configured to calculate a vehicle speed of the vehicle based on the vehicle data of the original storage;
a slope calculator configured to calculate a slope of the vehicle based on the vehicle data of the original storage and the corrected inertia signal;
a lateral direction speed calculator configured to calculate a lateral direction speed of the vehicle based on the vehicle data of the original storage and the corrected inertia signal;
a rainfall determinator configured to calculate water quantity applied to the vehicle based on the vehicle data of the original storage;
a fuel weight calculator configured to calculate a fuel weight of the vehicle based on the vehicle data of the original storage; and
a data gatherer configured to generate the feature data by gathering the corrected inertia signal from the data corrector, the vehicle speed from the vehicle speed calculator, the slope from the slope calculator, the lateral direction speed from the lateral direction speed calculator, the water quantity from the rainfall determinator, and the fuel weight from the fuel weight calculator, and output the generated feature data as one data set.

9. The vehicle occupant monitoring device of claim 5, wherein the occupant predictor comprises:
a normalizer configured to normalize the feature data from the feature extractor based on an average and standard deviation of the vehicle data provided from the setting value storage;
a model generator configured to generate an occupant prediction model based on the weight and the bias value of the vehicle data loaded from the setting value storage; and
a predicted value outputter configured to input the normalized feature data from the normalizer to the occupant prediction model from the model generator and output a value of the vehicle occupant.

10. The vehicle occupant monitoring device of claim 1, further comprising:
an instructor configured to instruct the vehicle data provider to collect and gather the vehicle data from the vehicle by detecting movement of the vehicle.

11. A vehicle occupant monitoring method comprising:
providing vehicle data collected from a vehicle; and
predicting vehicle occupants by analyzing the provided vehicle data by an artificial intelligence method.

12. The vehicle occupant monitoring method of claim 11, wherein the providing of the vehicle data comprises:
collecting an inertia signal from the vehicle;
collecting a diagnostic signal from the vehicle; and
gathering the inertia signal and the diagnostic signal.

13. The vehicle occupant monitoring method of claim 11, further comprising:
storing a model setting value calculated by machine learning of the artificial intelligence method in advance to infer the vehicle occupants corresponding to the vehicle data,
wherein the predicting of the occupants comprises:
extracting feature data based on the provided vehicle data; and
predicting the vehicle occupants by analyzing the extracted feature data by the artificial intelligence method through an occupant prediction model set based on the model setting value.

14. The vehicle occupant monitoring method of claim 13, wherein the extracting of the feature data comprises:
storing vehicle data input from an outside; and
extracting the feature data from the stored vehicle data.

15. The vehicle occupant monitoring method of claim 13, further comprising:
storing a value of the predicted vehicle occupants.

16. The vehicle occupant monitoring method of claim 14, wherein the extracting of the feature data comprises:
generating a corrected inertia signal by correcting an inertia signal of the vehicle based on the stored vehicle data and the center of gravity of the vehicle;
calculating a vehicle speed of the vehicle based on the stored vehicle data;
calculating a slope of the vehicle based on the stored vehicle data and the corrected inertia signal;
calculating a lateral direction speed of the vehicle based on the stored vehicle data and the corrected inertia signal;
calculating water quantity applied to the vehicle based on the stored vehicle data;
calculating a fuel weight of the vehicle based on the stored vehicle data; and
generating the feature data by gathering the calculated corrected inertia signal, the vehicle speed, the slope, the lateral direction speed, the water quantity, and the fuel weight to output the generated feature data as one data set.

17. The vehicle occupant monitoring method of claim 13, wherein the predicting of the vehicle occupants by analyzing the extracted feature data by the artificial intelligence method comprises:
normalizing the feature data based on an average and standard deviation of the vehicle data included in the model setting value;
generating an occupant prediction model based on a weight and a bias value of the vehicle data included in the model setting value; and
inputting the normalized feature data to the occupant prediction model and outputting a value of the vehicle occupants.

18. The vehicle occupant monitoring method of claim 11, further comprising:
instructing to collect and gather the vehicle data from the vehicle by detecting movement of the vehicle.
